(19) United States
(12) Patent Application Publication
(10) Pub. No.: US 2024/0119746 A1
(43) Pub. Date: Apr. 11, 2024

(54) APPARATUSES, SYSTEMS AND METHODS FOR GENERATING SYNTHETIC IMAGE SETS

(71) Applicant: University of Washington, Seattle, WA (US)

(72) Inventors: Jonathan Teng-Chieh Liu, Seattle, WA (US); Weisi Xie, Seattle, WA (US); Nicholas P. Reder, Seattle, WA (US)

(21) Appl. No.: 18/271,203

(22) PCT Filed: Jan. 10, 2022
(86) PCT No.: PCT/US2022/011838

§ 371 Date: Jul. 6, 2023

Related U.S. Application Data
(60) Provisional application No. 63/136,605, filed on Jan. 12, 2021.

(51) Int. Cl. G06V 20/69; G06T 3/4038; G06T 7/11; G06T 11/00; G06V 20/70

(52) U.S. Cl. CPC G06V 20/695; G06T 3/4038; G06T 7/11; G06T 11/00; G06V 20/70

(57) ABSTRACT

Apparatuses, systems, and methods for synthetic 3D digital microscopy image sets. A microscope captures a depth stack of a sample using a first labelling technique. A trained machine learning model generates a synthetic depth stack of images based on the imaged depth stack. The synthetic depth stack mimics the appearance of a second labelling technique, which is targeted to a tissue structure of interest. A segmentation mask is generated based on the synthetic depth stack. The machine learning model may be trained on depth stacks of samples prepared with both the first and the second labelling techniques.

### CROSS-REFERENCE TO RELATED APPLICATION(S)

This application claims the benefit under 35 U.S.C. § 119 of the earlier filing date of U.S. Provisional Application Ser. No. 63/136,605 filed Jan. 12, 2021, the entire contents of which is hereby incorporated by reference in its entirety for any purpose.

### STATEMENT REGARDING RESEARCH & DEVELOPMENT

This invention was made with government support under W81XWH-18-10358 awarded by the Department of Defense, and under 1934292 awarded by the National Science Foundation. The government has certain rights in the invention.

### TECHNICAL FIELD

Embodiments of the invention relate generally to image analysis, and particularly to segmentation of microscopy images.

### BACKGROUND

Three-dimensional (3D) microscopy of tissue specimens can yield large amounts of high-resolution micro-scale structural information, which can lead to important biological discoveries or used for clinical assays. For both biological studies and clinical assays, a first step in analyzing large 3D microscopy datasets is often to first extract (or segment) out key tissue structures so that those structures can be quantified. For example, it may be necessary to segment out specific cell types such as immune cells to quantify their spatial distributions and relationships with other cell types such as tumor cells. Likewise, it may be helpful to segment out tissue structures such as vessels or glands in order to extract quantitative “features” (geometric parameters) that can be predictive of disease aggressiveness (i.e. prognosis) or predictive of response to specific forms of therapy. In order to train a computational machine-learning model to segment such structures, it is often necessary to obtain a large number of “annotations” in which human experts have manually outlined those structures to train the computer. This is labor-intensive and subjective. Human's annotations are always subjective and imperfect; for example, publications show large “inter-observer variability” between pathologists. Any clinical assay or biological analysis based on human annotations will therefore be biased by the human observer(s). Alternatively, certain structures express specific molecular biomarkers that can be labeled with tracers, such as fluorescent antibodies. These immunolabeled images can often facilitate more-straightforward segmentation of those specifically labeled structures. However, this is expensive (in the case of antibodies) and slow, especially for thick 3D tissues through which large antibodies must diffuse over long distances.

### SUMMARY

In at least one aspect, the present disclosure relates to a method which includes labelling a first tissue sample with a first labelling technique and a second labelling technique. The second labelling technique is targeted to a tissue structure of interest and the first labelling technique has a lower specificity to the tissue structure. The method also includes collecting a first depth stack of images of the tissue, training a machine learning model using the first depth stack of images to generate synthetic images of the tissue structure as they appear with the second labelling technique based on images using the first labelling technique, and segmenting the tissue structure of interest in a second depth stack of images of a second tissue sample prepared with the first labelling technique based on the trained machine learning model.

The machine learning model may process a selected slice of the second depth stack of images along with slices adjacent to the selected slice. The machine learning model may be a vid2vid general adversarial network (GAN). The first labelling technique may include labelling with H&E analogs, Mason's tri-chrome, periodic acid-Schiff (PAS), 4′,6-diamidino-2-phenylindole (DAPI) or combinations thereof, and the second labelling technique may include labelling with aptamers, antibodies, peptides, nanobodies, antibody fragments, enzyme-activated probes, and fluorescent in situ hybridization (FISH) probes. The first labelling technique, the second labelling technique or combinations thereof may include label free imaging. The second labelling technique may be targeted to a biomarker associated with the tissue structure of interest.

The method may also include diagnosing a condition, monitoring the condition, making a prediction about progression of the condition, making a prediction about treatment response, or combinations thereof based on the identified structure of interest in the second depth stack of images. The method may also include taking a third depth stack of images of the second tissue sample and generating a mosaic image based on the second and the third depth stack of images. The method may also include generating a synthetic depth stack based on the second depth stack and the machine learning model. The synthetic depth stack may predict the appearance of the second tissue if it were prepared with the second labelling technique. The method may include segmenting the tissue structure of interest in the second depth stack of images based on the synthetic depth stack.

In at least one aspect, the present disclosure may relate to a method which includes generating a first set of images of a tissue sample, generating a second set of images of the tissue, and training a machine learning model to generate synthetic images from the first set of images which predict an appearance of the second set of images. The second set include targeted labelling of a tissue structure of interest of the tissue sample, and the first set of images are less specific to the tissue structure.

The method may also include generating a third set of images of a second tissue sample, where the third set of images are less specific to the tissue structure of interest, and segmenting the tissue structure of interest in the third set of images based on using the trained machine learning model on the third set of images. The method may also include training a general adversarial network (GAN) as the machine learning model. The first set of images and the second set of images may be a depth stack of the tissue. The method may also include training the machine learning model to generate the synthetic images based on iteratively processing a selected slice of the depth stack along with neighboring slices of the depth stack.

In at least one aspect, the present disclosure may relate to a method which includes imaging a depth stack of images of a tissue using a first labelling technique and generating a synthetic depth stack of images from the imaged depth stack of images using a machine learning model. The synthetic depth stack of images predict an appearance of the tissue as if it was prepared using a second labelling technique and the second labelling technique is targeted to a tissue structure of interest and the first labelling technique is less specific to the tissue structure of interest.

The method may also include segmenting the tissue structure of interest based on the synthetic depth stack of images. The method may also include segmenting the tissue structure of interest based on the depth stack of images. The method may also include diagnosing a condition, monitoring the condition, making a prediction about progression of the condition or combinations thereof based on the synthetic depth stack of images. The method may also include training the machine learning model based on a second depth stack of images of a tissue prepared using the first labelling technique and the second labelling technique. The method may also include imaging the depth stack of images of the tissue using an open top light sheet microscope.

In at least one aspect, the present disclosure may relate to an apparatus which includes a microscope which generates a depth stack of images of a tissue prepared with a first labelling technique, a processor, and a memory. The memory is encoded with executable instructions which, when executed by the processor cause the processor to generate a synthetic depth stack of images from the imaged depth stack of images using a machine learning model, wherein the synthetic depth stack of images predict an appearance of the tissue like it was prepared with a second labelling technique. The second labelling technique is targeted to a tissue structure of interest and the first labelling technique is less specific to the tissue structure of interest.

The tissue may have a thickness of 5 um or greater. The microscope may be an open top light sheet (OTLS) microscope. The machine learning model may be trained on a depth stack of images of a second tissue prepared with the first labelling technique and the second labelling technique. The first labelling technique may include labelling the tissue with H&E analogs, Mason's tri-chrome, periodic acid-Schiff (PAS), 4′,6-diamidino-2-phenylindole (DAPI) or combinations thereof, and the second labelling technique may include labelling the tissue with aptamers, antibodies, peptides, nanobodies, antibody fragments, enzyme-activated probes, and fluorescent in situ hybridization (FISH) probes. The machine learning model may be trained on another processor. The memory may also include instructions which, when executed by the processor, cause the apparatus to generate a segmentation mask based on the synthetic depth stack of images. The memory may also include instructions which, when executed by the processor, cause the apparatus to generate the segmentation mask based on the synthetic depth stack of images and the imaged depth stack of images

### BRIEF DESCRIPTION OF THE DRAWINGS

FIG. 1 is a block diagram of an optical system according to some embodiments of the present disclosure.

FIG. 2 is a method of training a machine learning model according to some embodiments of the present disclosure.

FIG. 3 is a flow diagram depicting a method of processing images according to some embodiments of the present disclosure.

FIG. 4 is a flow chart of a method of generating synthetic images according to some embodiments of the present disclosure.

FIG. 5 is a flow chart of a method of segmenting synthetic images according to some embodiments of the present disclosure.

FIG. 6 is a set of example images showing the segmentation of synthetic images according to some embodiments of the present disclosure.

FIG. 7 is a set of example images according to some embodiments of the present disclosure.

FIG. 8 is a method according to some embodiments of the present disclosure.

### DETAILED DESCRIPTION

The following description of certain embodiments is merely exemplary in nature and is in no way intended to limit the scope of the disclosure or its applications or uses. In the following detailed description of embodiments of the present systems and methods, reference is made to the accompanying drawings which form a part hereof, and which are shown by way of illustration specific embodiments in which the described systems and methods may be practiced. These embodiments are described in sufficient detail to enable those skilled in the art to practice presently disclosed systems and methods, and it is to be understood that other embodiments may be utilized and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The following detailed description is therefore not to be taken in a limiting sense, and the scope of the disclosure is defined only by the appended claims.

Various example values are given throughout the specification. It should be understood that these values are approximate, as perfect alignment may not be possible in a real-world system. Thus values such as ‘normal’ or ‘orthogonal’ should be interpreted as “approximately 90°” where the actual value may be within a tolerance of the desired angle. For example, two things which are described as orthogonal may be positioned anywhere from 85-95° with respect to each other. Other angles and measurements should be interpreted in a similar manner.

Microscopy may be used in a wide array of applications to produce images of a sample, usually with a field of view and/or resolution which are not normally visible to the naked eye. Illumination light may be directed onto a sample with illumination optics. Collection optics may be used to collect light from the sample onto a detector (for example, a CCD detector, a CMOS detector, or a user's eyes).

Various combinations of sample preparation and imaging techniques (here collectively referred to as a labelling technique) may be used to highlight one or more features of interest in a sample. Some labelling techniques may be highly targeted to a tissue structure of interest. For example, fluorescent antibodies may specifically bind to the antigen they are targeted against, and the antigen may be one which has a different expression level in the feature of interest than in the surrounding tissue. In such a labelling technique, when viewed under fluorescent imaging, the tissue structure of interest may be easily discernable since the fluorescent antibody is selectively bound to the tissue structure of interest. Other labelling techniques may be less specific to the bio-marker but may still be used to visualize the tissue structure of interest. For example, general staining techniques may stain the cytoplasm one color and nuclear material a different color. Various structures may be apparent including the tissue structure of interest, however it may be more difficult to discern due to the similar labelling of other surrounding structures. For example, it may require an expert microscopist, biologist, pathologist, and/or other specialist with expertise in the tissue sample of interest to identify tissue structures based on morphology, general appearance, etc., and automated segmentation of the tissue structure of interest may be difficult.

While labelling techniques that include targeted labelling of biomarkers may allow for relatively easy segmentation of the features of interest, they may also come with notable drawbacks. For example, targeted labelling techniques are often time-consuming, expensive, less practical, or some combination thereof when compared to less specific labelling techniques. In addition, highly specific targeted labels may preclude the visualization and segmentation of other structures of interest, necessitating complex (and more expensive) multiplexed labeling and imaging strategies. However, segmentation of features of interest may be most efficient on images generated from targeted labelling techniques, and users may be comfortable with the appearance of images generated using such techniques. It may be useful to generate images in the style of images captured using targeted labelling techniques from images captured from samples prepared with less specific labelling techniques.

The present disclosure is directed to generating synthetic image sets. A tissue may be labelled with a first labelling technique and imaged by a microscope to generate a 3D data set (e.g., a depth stack of images). A trained machine learning model may generate synthetic images which estimate the appearance of the 3D data set as if it had been labelled with a second labelling technique (e.g., a labelling technique targeted to a specific biomarker). The synthetic images may then be segmented to highlight or mark tissue structures of interest. The first labelling technique may be less specific to tissue structure of interest (e.g., a general labelling technique). Accordingly, the actual sample preparation and imaging may be relatively quick, simple, and/or inexpensive compared to using a targeted labelling technique, but the synthetic images may still offer the advantages of targeted labelling. The machine learning model is trained with a data set based on images of a tissue prepared with both the first and the second labelling technique. In some embodiments, the synthetic images may be generated from a 3D depth stack by processing each slice while also taking into account slices neighboring (e.g., adjacent to) the current slice. For example, the machine learning model may analyze multiple slices during training and manipulate multiple slices while generating the synthetic images.

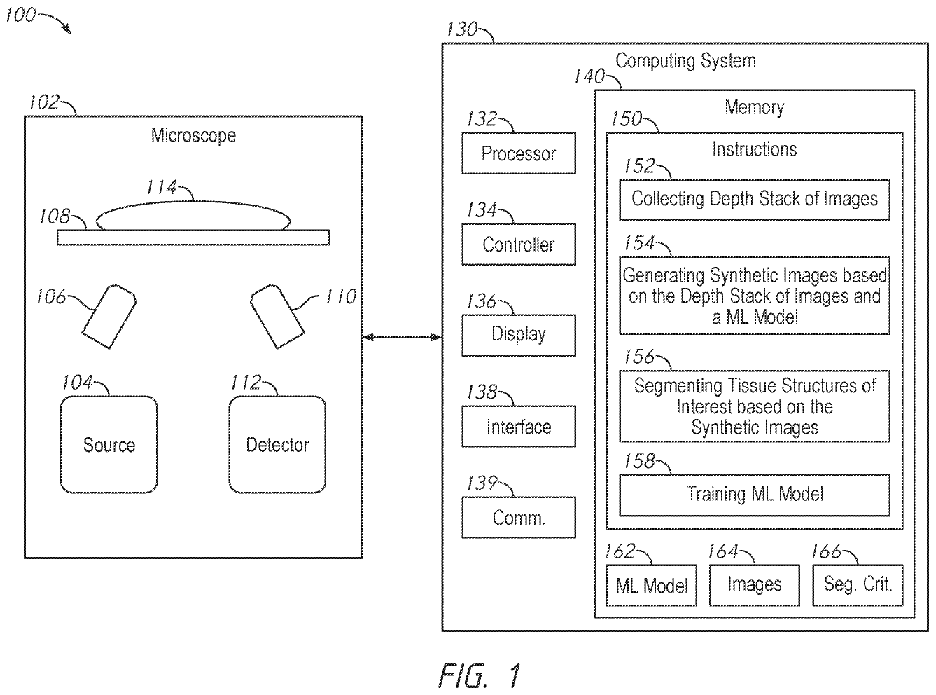

FIG. 1 is a block diagram of an optical system according to some embodiments of the present disclosure. FIG. 1 shows an optical system 100 which includes a microscope and a computing system 130 which operates the microscope 102 and/or interprets information from the microscope 102. In some embodiments, one or more parts of the computing system 130 may be integrated into the microscope 102. In some embodiments, the computing system may be a stand-alone component (e.g., a commercial desktop computer) which is coupled to the microscope 102. In some embodiments, the computing system 130 may be remote from the microscope and may not directly operate or communicate with the microscope 102. For example, the microscopic images may be captured in a first location, and then loaded onto the computing system 130 at some later time in a second location (e.g., via removable media, wired or wireless communication, etc.).

The microscope 102 includes a source 104 which generates illumination light and illumination optics 106 which direct the illumination light onto a sample 114. The microscope includes collection optics 110 which receive light from the sample 114 and direct the received light onto a detector 112. The illumination and collection optics 106 and 110 may each reshape, filter or otherwise alter the light passing through them. The detector 112 generates one or more signals which represent a captured image of the received light. In some embodiments, a sample holder 108 may be used to support the sample 114. While a particular arrangement and type of microscope may be described herein, it should be understood that the disclosure is not limited to any one microscope or type of microscope. For example, some embodiments may include a microscope in which a single objective is used as part of both the illumination and collection optics 106 and 110 and/or in which a fiber is used to image a sample 114 which is an in vivo tissue.

The computing system 130 may include one or more of a processor 132 which executes various operations in the computing system 130, a controller 134 which may send and receive signals to operate the microscope 102 and/or any other devices based on instructions from the processor 132, a display 136 which presents information to a user, an interface 138 which allows a user to operate the computing system 130, and a communications module 139 which may send and receive data (e.g., images from the detector 112). The computing system 130 includes a memory 140, which includes various instructions 150 which may be executed by the processor 132. As described in more detail herein, the instructions 150 may cause the processor 132 to generate synthetic images based on a set of images (e.g., a depth stack) taken of the sample 114 using a trained machine learning (ML) model 162. The images may be collected based on a first labelling technique while the synthetic images may predict a second labelling technique which is targeted to a biomarker in the sample 114. The ML model 162 may be trained using the computing system 130 or may be trained separately and provided to the computing system 130 as a pre-trained model. In some embodiments, one or more components/processes may be remote. For example, in some embodiments, the trained ML model 162 may be located on a server and the computing system 130 may send images 164 to the server and receive synthetic images back.

The sample 114 may be prepared with one or more labelling techniques, which may be used to visualize one or more aspects of the sample 114. As used herein, ‘labelling technique’ may refer both to any preparation of the sample and any corresponding imaging modes used to generate images of the sample. For example, if the labelling technique involves a fluorophore, then imaging the sample with the labelling technique may also include using fluorescent microscopy to image the fluorophore. Labelling techniques may include various sample preparation steps, such as washing, optical clearing, mounting, and other techniques known in the art. Some labelling techniques may include applying exogenous contrast agents (e.g., fluorescent dyes, stains, etc.) to the sample 114. Some labelling techniques may rely on inherent optical properties of the sample 114 (e.g., endogenous fluorophores, relying on tissue pigmentation, darkfield) and may not need additional contrast agents.

Some labelling techniques may include ‘label-free’ imaging, where some inherent optical property of the tissue is imaged without the need to apply an exogenous contrast agent. For example, fluorescent imaging may be used to image endogenous fluorophores of the tissue, without the need to add additional fluorophores to the sample. Label free imaging techniques may still include sample preparation steps such as sectioning or optical clearing. Some label-free imaging techniques may be specific, such as second harmonic generation (SHG) imaging, which may be used to specifically target collagen fibers due to the unique “noncentrosymmetric” molecular structure of those fibers.

A sample 114 may be prepared using multiple labelling techniques. For example, a stain may be applied as well as a fluorescent dye, and the sample may be imaged using brightfield to capture the stain and fluorescent imaging to capture the dye. In another example, multiple stains may be used together and may all be captured by the same imaging mode (e.g., multiple dyes may be visualized using a single brightfield image). In another example, multiple different fluorescent dyes may be used, and the microscope 102 may use a first set of filters (e.g., a first excitation filter and emission filter) to image a first fluorescent dye, a second set of filters to image a second fluorescent dye, etc. If multiple labelling techniques are used on a same sample 114, then it may be possible for the microscope 102 to capture multiple images of a given field of view, each imaging a different label.

Some labelling techniques are specifically targeted to the tissue of interest, and others are less specific. Targeted labelling techniques may include contrast agents with a targeting moiety and a signal-generation moiety. The targeting moiety may be used to selectively cause the signal-generation moiety to be localized in all or part of the tissue structure of interest. For example, the targeted moiety may selectively bind to a biomarker which is associated with the tissue of interest. For example, if the tissue structure of interest is a particular gland, then the targeting moiety may be used to target a biomarker expressed in those glandular cells but not in other cells and tissue components, or overexpressed in those glandular cells compared to other tissues, or not present in those glandular cells but present in other tissues. Another example of a targeted moiety may include chemicals which are selectively uptaken by tissues. For example, glucose analogues may be taken up by cancerous cells at a much higher rate than non-cancerous cells. The targeting moiety may be any marker which allows for visualization under one or more imaging modes. For example, fluorophores or dyes may be attached to the targeting moiety. In some embodiments, the targeting moiety may be bound to an signal-generation moiety to form a contrast agent (e.g., an antibody bound to a fluorophore). In some embodiments, the targeting moiety and signal-generation moiety may be an inherent properties of the contrast agent. For example, fluorescent glucose analogues may both be fluorescent and target cancerous cells. Examples of targeting moieties that may be used as part of a targeted labelling technique include aptamers, antibodies, peptides, nanobodies, antibody fragments, enzyme-activated probes, and fluorescent in situ hybridization (FISH) probes.

Some labelling techniques are less specific and may be used to image general tissue structures and/or broad types of tissue without specifically targeting any tissue structure of interest. For example, common cell stains, such as hematoxylin and eosin (H&E) or their analogs, may generally stain cellular nuclear material and cytoplasm respectively, without targeting any particular nuclear or cytoplasmic material. Examples of less specific labelling techniques include H&E analogs, Mason's tri-chrome, periodic acid-Schiff (PAS), 4′,6-diamidino-2-phenylindole (DAPI), and unlabeled imaging of tissue. In addition, endogenous signals, imaged without external contrast agents, can also be used as part of a label free imaging technique to provide general tissue contrast. For example, reflectance microscopy and autofluorescence microscopy are examples of “label-free” imaging techniques that generate images that reveal a variety of general tissue structures.

Labelling techniques may be multiplexed. For example, a sample 114 may be labelled with an H&E analogue and also a fluorescent antibody targeted to a biomarker expressed only by a specific tissue structure of interest (e.g., a specific type of tissue or cell). The images generated using the fluorescent antibody will only (or primarily) show the structure of interest, since the fluorophore is only (or primarily) bound to that specific tissue type. The images generated using the H&E analogue labelling technique will also show that type of tissue (since all tissues include nuclear and cytoplasmic material), but will also show other types of tissue. Accordingly, the tissue structure of interest may still be detected in images generated using a less specific labelling technique, but identification of those features of interest may be more difficult.

The less specific labelling techniques (e.g., H&E analogs) may offer various advantages. For example, targeted labelling techniques (e.g., immunofluorescence) may use contrast agents with relatively high molecular weights (e.g., >10 kDa) compared to the low molecular weights (e.g., <10 kDa) of more general contrast agents. Accordingly, when 3D imaging is desired, it may take a relatively long amount of time for targeted contrast agents to diffuse through the sample. This may be impractical for some applications and may dramatically increase the time and cost of preparing and imaging a sample. The less specific labeling techniques may also enable multiple structures to be identified and segmented, rather than requiring multiplexed staining and imaging with many highly specific targeted contrast agents.

Embodiments of the present disclosure are not limited to any particular type or design of microscope. However, for purposes of explanation, a particular layout of microscope is shown as the microscope 102 of FIG. 1. In particular, the microscope 102 shown in FIG. 1 is an inverted microscope in which the collection optics 110 are located below the sample 114 and sample holder 108. More specifically, the microscope 102 may be an open top light sheet (OTLS) microscope, where the illumination and collection optics are separate, and wherein a principle optical axis of the illumination path is at an angle (e.g., orthogonal to) the principle optical axis of the collection path. The illumination light may be focused to a light sheet (e.g., focused such that it is much wider than it is thick) which may offer advantages in terms of 3D imaging of samples at high speeds using fast cameras 114.

The source 104 provides illumination light along an illumination path to illuminate a focal region of the sample 114. The source 104 may be a narrow band source, such as a laser or a light emitting diode (LED) which may emit light in a narrow spectrum. In some embodiments, the light may be a broadband source (e.g., an incandescent source, an arc source) which may produce broad spectrum (e.g., white) illumination. In some embodiments, one or more portions of the illumination light may be outside of the visible range. In some embodiments, a filter (not shown) may be used as part of the illumination optics 106 to further refine the wavelength(s) of the illumination light. For example, a bandpass filter may receive broadband illumination from the source 104, and provide illumination light in a narrower spectrum. In some embodiments, the light source 104 may be a laser, and may generate collimated light.

In some embodiments, the microscope 102 may have multiple imaging modes (e.g., brightfield, fluorescence, phase contrast microscopy, darkfield), which may be selectable. For example, in some embodiments, the microscope 102 may be used to image fluorescence in the sample 114. The illumination light may include light at a particular excitation wavelength, which may excite fluorophores in the sample 114. The fluorophores may be endogenous to the sample and/or may be exogenous fluorescent labels applied to the sample. The illumination light may include a broad spectrum of light which includes the excitation wavelength, or may be a narrow band centered on the excitation wavelength. In some embodiments, the light source 104 may produce a narrow spectrum of light centered on (or close to) the excitation wavelength. In some embodiments, filter(s) (not shown) may be used in the illumination optics 106 to limit the illumination light to wavelengths near the excitation wavelength. Once excited by the illumination light, the fluorophores in the sample 114 may emit light (which may be centered on a given emission wavelength). The collection path (e.g., collection optics 110) may include one or more filters which may be used to limit the light which reaches the detector 112 to wavelengths of light near the emission wavelength. In some embodiments, the microscope 102 may have multiple sets of illumination and/or collection filters and which fluorophore(s) are currently imaged may be selectable.

The illumination optics 106 may direct the light from the source 104 to the sample 114. For example, the illumination optics 106 may include an illumination objective which may focus the light onto the sample 114. In some embodiments, the illumination optics 106 may alter the shape, wavelength, intensity and/or other properties of the light provided by the source 104. For example, the illumination optics 106 may receive broadband light from the source 104 and may filter the light (e.g., with a filter, diffraction grating, acousto-optic modulator, etc.) to provide narrow band light to the sample 114.

In some embodiments, the illumination path may provide an illumination beam which is a light sheet as part of light sheet microscopy or light-sheet fluorescent microscopy (LSFM). The light sheet may have a generally elliptical cross section, with a first numerical aperture along a first axis (e.g., the y-axis) and a second numerical aperture greater than the first numerical aperture along a second axis which is orthogonal to the first axis. The illumination optics 106 may include optics which reshape light received from the source 104 into an illumination sheet. For example, the illumination optics 106 may include one or more cylindrical optics which focus light in one axis, but not in the orthogonal axis.

In some embodiments, the illumination optics 106 may include scanning optics, which may be used to scan the illumination light relative to the sample 114. For example, the region illuminated by the illumination beam may be smaller than a focal region of the collection optics 110. In this case, the illumination optics 106 may rapidly oscillate the illumination light across the desired focal region to ensure illumination of the focal region.

The sample holder 108 may position the sample 114 such that the illumination region and focal region is generally within the sample 114. The sample 114 may be supported by an upper surface of the sample holder 108. In some embodiments, the sample 114 may be placed directly onto the upper surface of the sample holder 108. In some embodiments, the sample 114 may be packaged in a container (e.g., on a glass slide, in a well plate, in a tissue culture flask, etc.) and the container may be placed on the sample holder 108. In some embodiments, the container may be integrated into the sample holder 108. In some embodiments, the sample 114 may be processed before imaging on the optical system 100. For example, the sample 114 may be washed, sliced, and/or labelled before imaging.

In some embodiments, the sample 114 may be a biological sample. For example, the sample 114 may be a tissue which has been biopsied from an area of suspected disease (e.g., cancer). Other example samples 114 may include cultured cells, or in vivo tissues, whole organisms, or combinations thereof. In some embodiments, the tissue may undergo various processing, such as optical clearance, tissue slicing, and/or labeling before being examined by the optical system 100.

The sample holder 108 may support the sample 114 over a material which is generally transparent to illumination beam and to light collected from the focal region of the sample 114. In some embodiments, the sample holder 108 may have a window of the transparent material which the sample 114 may be positioned over, and a remainder of the sample holder 108 may be formed from a non-transparent material. In some embodiments, the sample holder 108 may be made from a transparent material. For example, the sample holder 108 may be a glass plate.

The sample holder 108 may be coupled to an actuator (not shown), which may be capable of moving the sample holder 108 in one or more directions. In some embodiments, the sample holder 108 may be movable in up to three dimensions (e.g., along the x, y, and z axes) relative to the illumination optics 106 and collection optics 110. The sample holder 108 may be moved to change the position of the focal region within the sample 114 and/or to move the sample holder 108 between a loading position and an imaging position. In some embodiments, the actuator may be a manual actuator, such as screws or coarse/fine adjustment knobs. In some embodiments, the actuator may be automated, such as an electric motor, which may respond to manual input and/or instructions from a controller 134 of the computing system 130. In some embodiments the actuator may respond to both manual adjustment and automatic control (e.g., a knob which responds to both manual turning and to instructions from the controller 134).

The microscope 102 may be used to generate a depth stack (or z-stack) of images. For example the actuator may position the sample 114 such that a first image is taken with the image being generally in an x-y plane. The actuator may then move the sample 114 a set distance along an axis orthogonal to the imaging plane (e.g., along the z-axis), and a second image may be captured. This may be repeated a number of times to build up a set of 2D images which represent a 3D volume of the sample 114. In some embodiments, multiple depth stacks may be collected by generating a depth stack at a first location and then moving the sample holder along the x and/or y-axis to a second location and generating another depth stack. The depth stacks may be mosaicked together to generate a 3D mosaic of a relatively large sample. In some embodiments, the optical system 100 may collect depth stacks of relatively thick tissue samples. For example, in some embodiments the depth stack may be greater than 5 um thick. In some embodiments, the sample 114 may be larger, such as biopsy samples, and the depth stacks may be a millimeter or more thick.

The collection optics 110 may receive light from a focal region and direct the received light onto a detector 114 which may image and/or otherwise measure the received light. The light from the focal region may be a redirected portion of the illumination beam (e.g., scattered and/or reflected light), may be light emitted from the focal region in response to the illumination beam (e.g., via fluorescence), or combinations thereof.

The collection optics 110 collect light from the sample 114 and direct that collected light onto the detector 112. For example, the collection optics 110 may include a collection objective lens. In some embodiments, the collection optics 110 may include one or more elements which alter the light received from the sample 114. For example, the collection optics 110 may include filters, mirrors, de-scanning optics, or combinations thereof.

The detector 112 may be used for imaging the focal region. In some embodiments, the detector 112 may include an eyepiece, such that a user may observe the focal region. In some embodiments, the detector 112 may produce a signal to record an image of the focal region. For example, the detector 112 may include a CCD or CMOS array, which may generate an electronic signal based on the light incident on the array.

The microscope 102 may be coupled to a computing system 130 which may be used to operate one or more parts of the microscope 102, display data from the microscope 102, interpret/analyze data from the microscope 102, or combinations thereof. In some embodiments, the computing system 130 may be separate from the microscope, such as a general purpose computer. In some embodiments, one or more parts of the computing system 130 may be integral with the microscope 102. In some embodiments, one or more parts of the computing system may be remote from the microscope 102.

The computing system 130 includes a processor 132, which may execute one or more instructions 150 stored in a memory 140. The instructions 150 may instruct the processor 132 to operate the microscope 102 (e.g., via controller 134) to collect images 164, which may be stored in the memory 140 for analysis. The images 164 may be analyzed ‘live’ (e.g., as they are collected or shortly thereafter) or may represent previously collected imaging. In some embodiments, the computing system 130 may be remotely located from the microscope and may receive the images 164 without any direct interaction with the microscope 102. For example, the microscope 102 may upload images to a server and the communications module 139 of the computing system 130 may download the images 164 to the memory 140 for analysis.

The images 164 may represent one or more depth stacks of the sample 114. Each depth stack is a set of images which together represent slices through a 3D volume of the sample 114. The images 164 may include metadata (e.g., a distance between slices along the z-axis) which allows for orientation of the images (e.g., a reconstruction of the 3D volume). Multiple 3D volumes (e.g., multiple depth stacks) may be mosaicked together to form a larger overall 3D volume.

The instructions 150 include steps which direct the computing system 130 to operate the microscope 102 to collect images. For example, instructions 152 describe collecting a depth stack of images. The instructions 152 may include capturing a first image from the detector 112, moving the sample holder 108 a set distance (e.g., along a z-axis) capturing a second image, and so forth until a set number of images and/or a set distance along the z-axis has been achieved. In some embodiments, the instructions 152 may also include displacement along one or more other axes. For example, some microscope geometries may have images which do not lie in an x-y plane, and thus more complicated movements may be required to capture a stack of images. In some embodiments, the instructions 152 may be performed by a different computing system than the one which analyzes the images.

The captured images 164 may be imaged based on a first labelling technique which is not specifically targeted to a tissue structure of interest. For example, the images 164 may be captured using a general stain such as an H&E analog or a general nucleic acid stain such as DAPI. The captured images 164 may be imaged based on a labelling technique which captures details of the tissue structure of interest but which does not specifically target the tissue structure of interest.

The instructions 150 include instructions 154, which describe generating synthetic images based on the depth stack of images 164 and a machine learning model 162. The machine learning model 162 may be trained using a training set of images which are imaged with both the first labelling technique used to capture the images 164 and also a second labelling technique which is targeted to a biomarker associated with the tissue structure of interest. For example, if the biomarker is a nucleic acid sequence, then the second labelling technique may include an aptamer which binds to that sequence as a targeting moiety. The machine learning model may generate synthetic images from the captured images 164 which predicts the appearance and information of the images captured using the second labelling technique. The synthetic images may be also represent a 3D data set (e.g., the synthetic images may also be a depth stack).

In some embodiments, the instructions 154 may include processing the depth stack of captured images 164 on a slice by slice basis. In some embodiments, the instructions 154 may include processing each slice along with one or more neighboring slices (e.g., adjacent slices). This may be useful given that the depth stack of captured images 164 represent a 3D volume of the sample 114, and structures may extend across multiple slices of the stack.

In some embodiments, the synthetic images may be presented to a user (e.g., via display 136). In some embodiments, the synthetic images may be presented as an overlay over the captured images 164. In some embodiments, a user may be able to select how the images are displayed, and whether the synthetic or captured images are displayed. In some embodiments, a clinician or other user may receive the synthetic images and may use them as is. In some embodiments, the computing system may segment features of interest in the synthetic images.

The instructions 150 include instructions 156 which describe segmenting features of interest based on the synthetic images. The memory 140 may include various segmentation criteria 166, which may be used to segment the synthetic images. For example, a brightness threshold may be used to generate a binary mask which in turn may be used to segment out the features of interest. The segmentation criteria 166 may be based on features of images collected using the second labelling technique (e.g., present in the synthetic images). In some embodiments, the segmentation may include using features in both the synthetic image and in the originally captured images. The segmented images may be used for diagnosis, to determine treatment progress, to monitor disease progression, to predict future disease progression, etc.

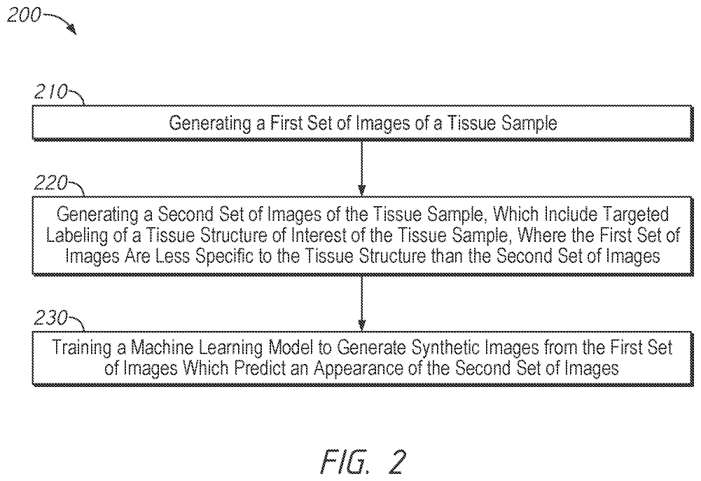

In some embodiments, the computing system 130 may also include instructions 158 for training the machine learning model 162. In some embodiments, the training of the machine learning model may be performed by a separate computing system and the trained machine learning model 162 may be loaded onto the computing system 130 for image analysis (e.g., instructions 154). In some embodiments, the training may be performed using the same computing system 130. The instructions 158 may include training the ML model on images of a sample labelled with both the first and the second labelling technique. An example ML training is described in more detail in FIG. 2.

It may not be necessary for the ML model 162 to be trained in a manner which exactly matches the first labelling technique used to collect the depth stack of images (e.g., in instruction 152). For example, the ML model 162 may be trained using images captured using a different microscope than the microscope 102. In another example, the ML model 162 may be trained using an analog of the contrast agent used to prepare the depth stack of images collected in instructions 152. For example, a first H&E analog may be used to generate the images 164, and a second H&E analog may be used to train the ML model 162.

FIG. 2 is a method of training a machine learning model according to some embodiments of the present disclosure. The method 200 may, in some embodiments, be an implementation of instruction 158 of FIG. 1.

The method 200 includes box 210 which describes generating a first set of images of a tissue sample. The first set of images may represent a depth stack of images through the tissue sample (e.g., 114 of FIG. 1). The first set of images may be images of a sample prepared with a first labelling technique. The method 200 also includes box 220 which describes generating a second set of images of the tissue sample. Similar to the first set of images the second set of images may also be a depth stack of images. The second set of images may be images of the sample prepared with a second labelling technique. The second labelling technique is targeted to a tissue structure of interest of the tissue sample. The first set of images, and the first labelling technique, are less specific to the tissue structure. For example, the first labelling technique may be a general labelling technique which also labels the tissue structure of interest, but is not specifically targeted to the tissue structure of interest.

The method 200 may include preparing a sample with a first labelling technique and a second labelling technique. For example, if the first labelling technique includes a first label (e.g., an H&E analogue) and the second labelling technique includes a second label (e.g., a fluorescent antibody) then the method 200 may include applying the first label and the second label to the sample.

In some embodiments, the two sets of images may be generated concurrent to each other and may include overlapping fields of view. For example, the method 200 may include imaging a field of view (e.g., a slice through the depth stack) using a first imaging mode (e.g., a first set of fluorescent filters) associated with the first labelling technique and then imaging the same field of view with a second imaging mode (e.g., a second set of fluorescent filters) associated with the second labelling technique. Accordingly, the two sets of images may be two sets of images of the same volume of the sample. Each slice through the depth stack may have an image in the first set of images and an image in the second set of images. Or in other words, each image in the first set of images may have a corresponding image in the second set of images which shares the same field of view.

The method 200 may include box 230 which describes training a machine learning model to generate synthetic images from the first set of images which predict an appearance of the second set of images. The machine learning model may be trained to generate synthetic images from the first set of images which predict the appearance of the corresponding image from the second set of images. For example, the synthetic images may match both the general appearance (e.g., color, illumination) as well as the information (e.g., which structures are labelled) of the second set of images.

In some embodiments, the machine learning model may include a generative adversarial network (GAN). In some embodiments, the trained machine learning model may process the first set of images to generate synthetic images on a slice by slice basis through the depth stack. In some embodiments, the trained machine learning model may process the first set of images using a subset of neighboring images. The adjacent images may have a relatively high continuity of information (e.g., because 3D structures extend through the depth stack), and thus processing subsets of adjacent slices may speed up a processing time. For example, the machine learning model may adapt a vid2vid method of video translation. The vid2vid method uses the idea that subsequent images in a time series (e.g., a video) have high continuity of information. In embodiments of the present disclosure, the vid2vid method may be adapted based on the idea that neighboring slices in a depth stack have high continuity of information due to shared structures extending through the 3D volume.

In some embodiments, the machine learning model may select a slice and process that slice along with neighboring slices. In some embodiments, the number and distance of the neighboring slices from the selected slice may be variable (e.g., selected by the machine learning model, user selectable, etc.). In some embodiments, the machine learning model may adjust the number and distance of neighboring slices during processing. In some embodiments, the number and distance of neighboring slices may be fixed.

An example implementation of the machine learning model, which may include a vid2vid GAN, may include 3 parts: a sequential generator, an image discriminator, and a video discriminator. The goal of the sequential generator is to output a realistic 2D frame in the target domain at each time point while leveraging the input video and previously generated output video at two previous frames to enforce temporal continuity. The purpose of the image discriminator is to ensure that each output frame resembles a real image given the same source image. The purpose of the video discriminator is to ensure that consecutive output frames resemble the temporal dynamics of a real video. The video discriminator is also temporally multi-scale by downsampling the frame rates of the real/generated videos. In the finest scale, the discriminator takes K consecutive frames in the original sequence as input. In the next scale, the video is subsampled by a factor of K, and the discriminator takes consecutive K frames in this new sequence as input. This is done for up to three scales to help ensure both short-term and long-term consistency. During training, in each epoch for each video sample, one frame is randomly selected from the video to compute the image discriminator loss, and K consecutive frames are randomly retrieved from the video (with different temporal down-sampling) to compute the video discriminator loss. In some embodiments, K may be set to 3, however larger or smaller values of K (e.g., 1, 2, 4, 5, etc.) may be used in other embodiments. In some embodiments, the generator and discriminators of the vid2vid GAN may be hardware components of a computing system (e.g., 130 of FIG. 1), may be implemented in software (e.g., in instructions 150), or combinations thereof. An example machine learning model including a vid2vid GAN is described in Wang, Ting-Chun et al, “Video-to-video synthesis.” arXiv preprint arXiv: 1808.06601 (2018), which is hereby incorporated by reference in its entirety for any purpose.

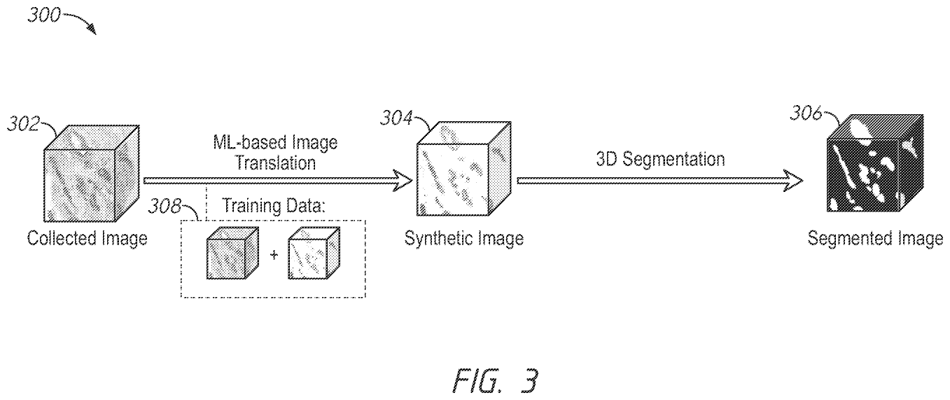

FIG. 3 is a flow diagram depicting a method of processing images according to some embodiments of the present disclosure. The method 300 may be an implementation of the instructions 152-156 of FIG. 1 in some embodiments. For the sake of illustration, FIGS. 3-7 show example data generated based on a particular application, locating glands in prostate tissue. Similarly, particular labelling techniques, namely using an H&E analog to stain cellular materials and generating synthetic images which predict anti-cytokeratin 8 (CK8) immunofluorescence images (which is expressed in glandular luminal epithelial cells) are used based on that application. These images and labelling techniques are discussed merely as an example and the present disclosure is not limited to such an application.

The method 300 includes receiving a set of collected images 302. The collected images 302 are a depth stack of images of the sample (in this case, prostate tissue). The collected images 302 may be generated using an optical system such as the optical system 100 of FIG. 1. The collected images are generated using a first labelling technique, in this case an H&E analogue stain. The first labelling technique stains cytoplasm a first color, while nuclear material is stained a second color. As may be seen, a variety of gross structural features are visible in the collected images 302. Glands are visible in the collected images 302, however they may be difficult to segment out of the image.

The collected image 302 shows a representation of a depth stack taken of a 3D volume. The collected image 302 may include several individual 2D images (e.g., slices) which together make up the 3D volume. In some embodiments, the collected image 302 may represent one depth stack of a mosaic.

The method 300 shows that synthetic images 304 are generated from the collected images 302 based on a trained ML model. The synthetic images 304 may be generated using a computing system, such as the computing system 130 of FIG. 1. The trained ML model generates synthetic images which predict a second labelling technique which is targeted to a specific biomarker. In this case, the second labelling technique is immunofluorescence targeted to the CK8 protein expressed in prostate glands. As may be seen from the synthetic images 304, the glands are clearly visible since they are the only features which are labelled with a fluorescent dye in the image. Similar to the collected image 302, the synthetic images 304 may be a depth stack. The synthetic image 304 may predict the appearance of a depth stack of the same 3D volume imaged by the collected images 302 as if it was prepared to label CK8.

The method 300 shows that the synthetic images 304 may be used to segment the features of interest by generating a segmentation mask which in turn may be used to generate segmented image 306. In this case the glands may be segmented from the synthetic images using relatively straightforward segmentation techniques. For example, thresholding may be used on the synthetic images 304 to generate a binary mask of the glands as the segmentation mask. The segmentation image 306 may be a depth stack of segmentation images and may represent the same 3D volume imaged in the collected images 302.

The ML model may be trained on two sets of images of the same sample. The sample may be labelled with two labelling techniques, the labelling technique used to collect the collected images 302 (or an analogous imaging technique), and a labelling technique which is targeted to a biomarker associated with the tissue structure of interest. In this case, the training data 308 includes prostate tissue stained with an H&E analogue and also with anti-CK8 immunofluorescence. The ML model may be trained to generate synthetic images which appear as the immunolabelled images from images generated with the H&E analogue.

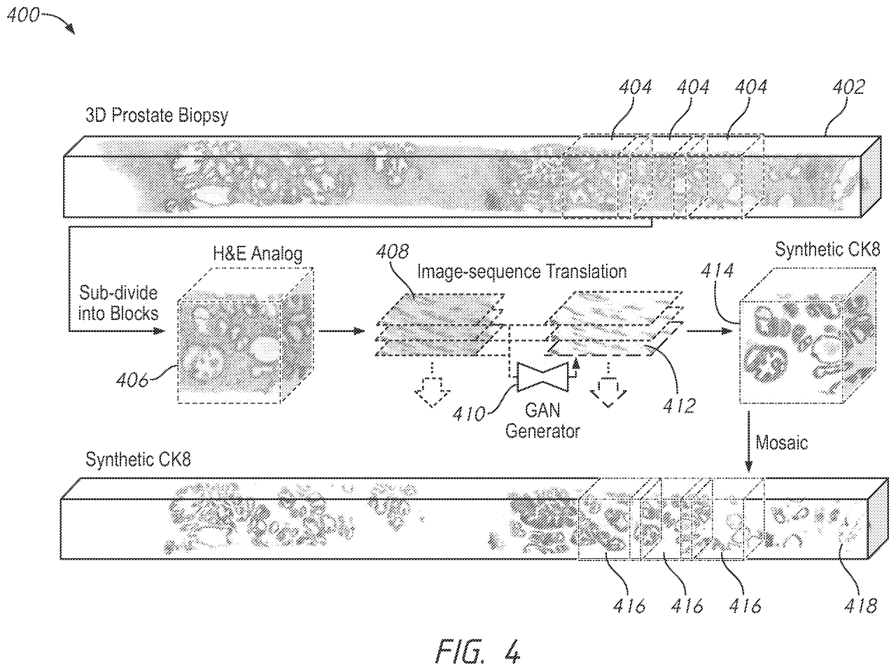

FIG. 4 is a flow chart of a method of generating synthetic images according to some embodiments of the present disclosure. The method 400 may, in some embodiments, represent an implementation of instructions 154 of FIG. 1 and/or the process or generating synthetic images 304 of FIG. 3. Similar to FIG. 3, FIG. 4 shows images and labelling techniques based on a specific application, the labelling to prostate tissue with an H&E analog and the generation of synthetic images which predict anti-CK8 immunofluoresence (which may be referred to as a CK8 image).

An optical system (e.g., 100 of FIG. 1) may capture images of a 3D volume. In the example of FIG. 4, the images represent a 3D image of a prostate biopsy 402. The biopsy 402 may be a 3D image constructed from multiple depth stacks which are mosaicked together. For example, depth stacks 404 are shown. The depth stacks may, in some embodiments, have overlapping edges, which may ease in construction of the overall mosaic. The 3D biopsy image 402 may be generated from tissue stained with a first labelling technique. It may be desirable to locate specific features of interest, however the first labelling technique is not targeted to those features of interest. The method 400 converts the 3D biopsy image 402 into a synthetic 3D biopsy image which appears as if prepared with a second labelling technique which is targeted to biomarkers present in the features of interest.

The method 400 includes separating out individual depth stacks 406 from the 3D volume. Each depth stack includes a number of ‘slices’, individual 2D images. The captured slices 408 may be used as input by a machine learning model 410, such as a GAN model. The GAN model may generate a set of synthetic slices based on the captured image slices 408. In some embodiments, the GAN model 410 may use multiple captured slices 408 to generate each synthetic slice 412. For example, a set of adjacent slices 408 may be used to generate each slice 412. The synthetic slices may have the appearance of tissue prepared with the second labelling technique. In some embodiments, each synthetic slice 412 may be generated based on a corresponding slice 408 and its adjacent slices 408. In other embodiments, different numbers of slices 408 and spatial relationships between them may be used to generate each synthetic slice 412.

The synthetic slices 412 may be reconstructed into a synthetic depth stack 414 which corresponds to the imaged depth stack 406. The synthetic depth stacks, such as 414, may be assembled together into a synthetic biopsy image 418. For example, multiple synthetic depth stacks 416, each generated from a depth stack 404 of the original image 402, may be mosaicked together to form the overall synthetic biopsy image 418. The synthetic biopsy image may correspond to the 3D volume imaged by the 3D biopsy 402.

Some embodiments of the system and method use machine learning methods originally developed to perform image translation on a time series of 2D images. However, the 3D image dataset (e.g., the depth stack 406) used as an input has depth data instead of time data. In other words the different slices represent sequential data in space rather than sequential data in time. One example of a ML model is a video-sequence translation tool, such as the “vid2vid” generative adversarial network (GAN). The model is valuable for ensuring high spatial continuity as a function of depth rather than high spatial continuity as a function of time (the original goal of the vid2vid GAN method).

In some aspects, instead of the processing taking place using the entire 3D image as input, the process takes place sequentially on a series of 2D slices from the 3D image, or on a small number of adjacent 2D slices, and the model ensures that there is good spatial continuity between adjacent frames. Comparing basic 2D versus 3D convolution operations, which are involved in convolutional neural networks in deep learning methods: on the same 3D block (size=N³), 2D convolution acts on each 2D slice with 2D kernels (size=n²) while 3D convolution acts on the entire 3D block with 3D kernels (size=n³). The time complexity for 2D convolutions on slices: O(N³n²), and for 3D convolutions: O(N³n³). Therefore, the ratio of time required for 3D vs 2D convolution is on the order of n, so 2D slice analysis is n times faster than the full 3D method. This depends on the kernel size n, and usually, n=3 or 5 (usually 3, less than 10) in most convolutional layers.

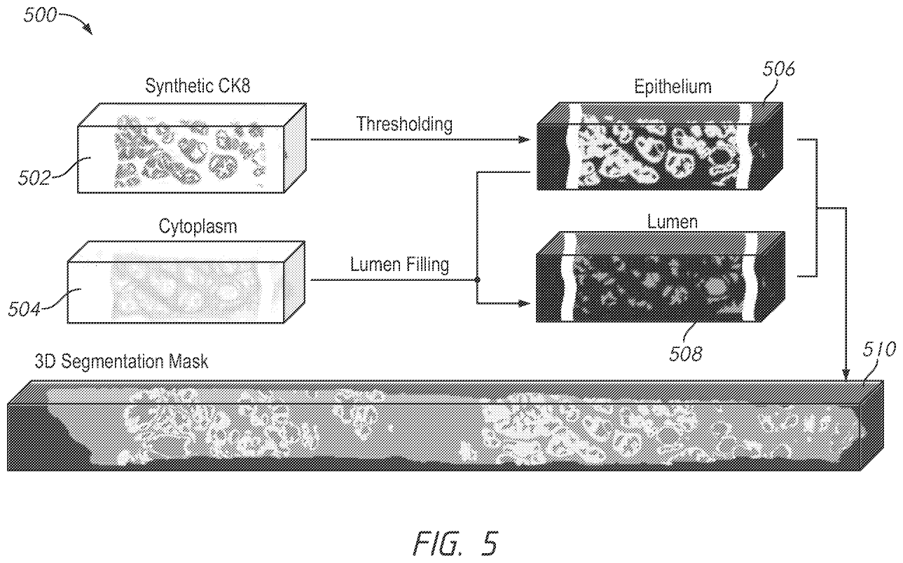

FIG. 5 is a flow chart of a method of segmenting synthetic images according to some embodiments of the present disclosure. The method 500 may, in some embodiments, be an implementation of the instruction 156 of FIG. 1. The method 500 of FIG. 5 shows using the synthetic image (e.g., 304 of FIG. 3) to generate a segmented image (e.g., 306 of FIG. 3). In particular, the method 500 shows an example segmentation process which may be used for an example application, and an example set of labelling techniques. In this case, the samples are prostate biopsies and the features of interest are glands, which may be useful for prostate cancer detection, diagnosis, and/or prognosis. Similar to FIG. 4, the example images of FIG. 5 involve imaging tissue stained with an H&E analog, then using a machine learning model (e.g., as in FIG. 4) to generate a synthetic 3D image which has the appearance of tissue stained with immunofluorescence against the CK8 biomarker, which is expressed by luminal epithelial cells of prostate glands. Some of the steps described with respect to FIG. 5 may be specific to this application, and other segmentation techniques and steps may be used in other example embodiments.

The method 500 includes a synthetic 3D image 502. The synthetic 3D image 502 was generated by a machine learning model to predict a targeted labelling technique (e.g., immunofluorescence of CK8) based on a 3D image 504 captured of a tissue stained with a less specific labelling technique (e.g., an H&E analog). The method 500 includes segmenting the image 502 to generate a mask 506 of luminal epithelial cells. Since the synthetic image 502 predicts targeted labelling of the luminal epithelial cells, simple segmentation methods such as thresholding may be used. In other words, the method 500 includes generating a mask 506 based on any pixels of the 3D image which have an intensity above a threshold.

The method 500 includes using the epithelial mask 506 as well as the captured image 504 to generate a lumen mask 508. The captured image 504 represents the image captured by the optical system (e.g., by microscope 102 of FIG. 1). In this case, the captured image 504 shows the cytoplasm of the imaged cells. Since an H&E analog was used, the cytoplasm may be separated out using color filtering (either physically, using optical filters on the microscope and/or using image processing). The method 500 includes lumen filling based on the epithelial mask 506 and the cytoplasm in the image 504 to generate a luminal mask 508. For example, a void in the cytoplasm surrounded by epithelial cells may represent a lumen and the lumen filling may generate a mask by filling in such spaces.

The method 500 includes combining the epithelial mask and luminal mask to generate an overall segmentation mask. Here the segmentation mask may be a 3D segmentation mask which is used to highlight both the epithelium and lumen of prostate glands. The information in the segmentation mask may be used for various applications. For example, a clinician may use the segmentation mask to diagnose prostate cancer, monitor the progression of prostate cancer, and/or predict disease progression. In some embodiments, one or more automated processes may be used to generate various metrics (quantitative features), such as the curvature of the boundary between the lumen and epithelium, and/or the gland-to-convex-hull ratio (G/H).

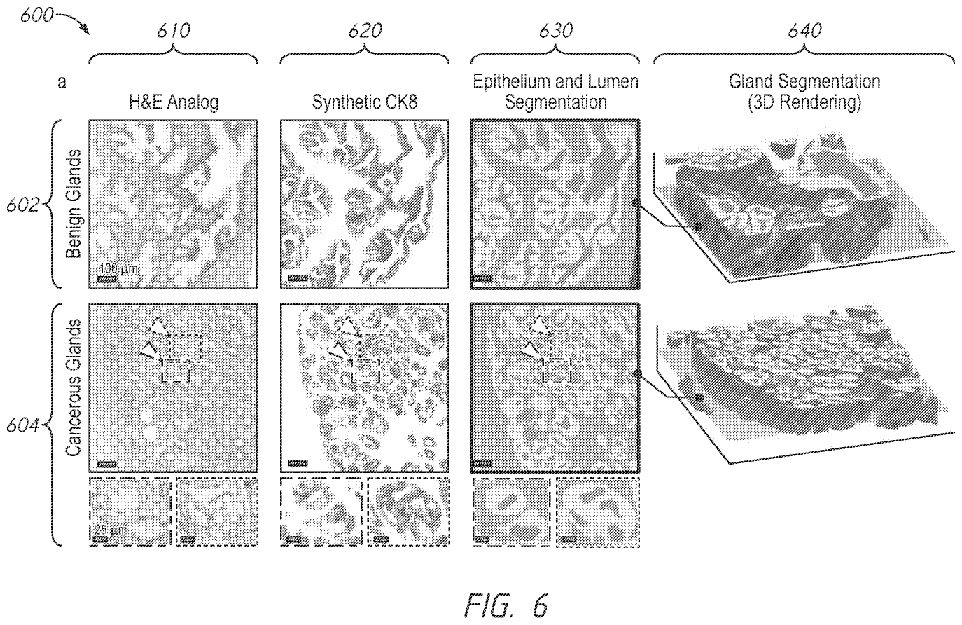

FIG. 6 is a set of example images showing the segmentation of synthetic images according to some embodiments of the present disclosure. The images 600 represent example images processed by an optical system such as the optical system 100 of FIG. 1 and/or the processes described with respect to FIGS. 3-5. In particular, the images 600 represent an example application where prostate tissue is imaged after being labelled with an H&E analog and a machine learning model is used to generate a synthetic image similar to an immunofluorescence CK8 image (e.g., the method 400 of FIG. 4) and then segmentation is used to detect the lumen and epithelium (e.g., the method 500 of FIG. 5).

The images 600 show a set of example images of benign glands 602 and example images of cancerous glands 604. The images of the cancerous glands 604 also include insets showing detailed cellular structure. Each set of images 602 and 604 includes a representative 2D image from a 3D depth stack of captured images 610 which are imaged with a first labelling technique (e.g., an H&E analog), a representative 2D synthetic image from a 3D depth stack of synthetic images 620 which predicts the appearance of the tissue sample as if it was prepared with a second labelling technique, a representative 2D image from a 3D depth stack of a segmentation mask 630 overlaid on the synthetic image, and a 3D rendering 640 based on the segmentation mask and the images.

As may be seen, while features such as glands are present in the original captured images 610, it may be relatively hard to determine features such as the lumen and epithelial walls, especially for an automated segmentation process. However, the segmentation masks 630 (and 3D renderings 640) generated from the synthetic images 620 clearly show such features and allow for more straightforward automated processing. In addition, clinicians may be used to the appearance of images in the format of the synthetic images 620, and may be more comfortable analyzing such images than if the segmentation mask 630 was developed directly from the captured images 610.

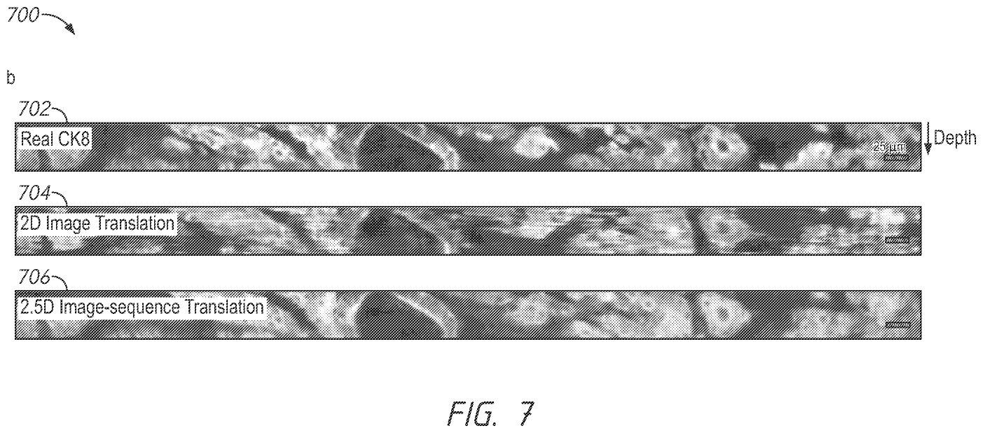

FIG. 7 is a set of example images according to some embodiments of the present disclosure. The images show examples of a captured image 702 using a targeted labelling technique (e.g., immunofluorescent labelling of CK8) compared to two synthetic images 704 and 706 generated from captured images using a different, less specific labelling technique (e.g., H&E analog). The synthetic images 704 and 706 may, in some embodiments, be generated using one or more of the systems and methods described in FIGS. 1-6.

The captured image 702 represents a “real” captured image of tissue labelled using a targeted labelling technique, in this case CK8 immunofluorescence. The sample is prepared, labelled with anti-CK8 fluorescent antibodies, and then imaged on a microscope (e.g., 102 of FIG. 1). For the sake of comparison, that same sample is also labelled with a less specific labelling technique, in this case an H&E analog. The sample is prepared and labelled with H&E and imaged on the microscope. The microscope may use different imaging modes (e.g., bright field vs. fluorescence, different fluorescent filters, etc.) to capture the different labelling techniques, so the same field of views may be captured using both labelling techniques. The H&E images may then be converted into synthetic CK8 images using a trained machine learning algorithm (e.g., using the method 300 of FIG. 3).

In the example of FIG. 7, two different techniques are used to generate the synthetic images 704 and 706 for comparison. The synthetic image 704 is generated using a machine learning model which only analyzes each 2D slice one at a time. The synthetic image 706 is generated using a machine learning model which takes into account subsets of slices (e.g., a slice and its neighboring slices) when generating the synthetic image. This may be referred to as a “2.5D” approach, because although each individual slice is 2D, the set may represent a portion of the 3D volume. As may be seen, both synthetic images 704 and 706 recreate the appearance of the captured image 702. However the synthetic image 706 shows there may be advantages to analyzing subsets of slices rather than single slices.

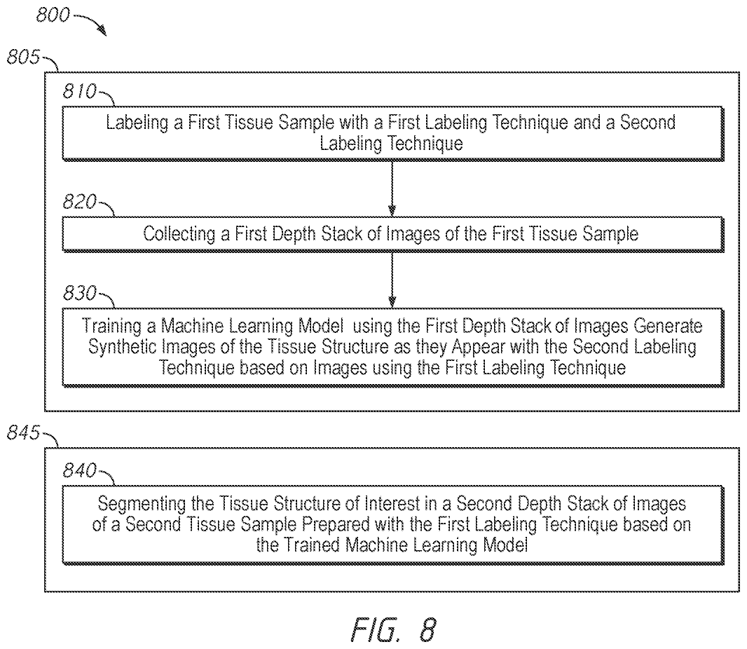

FIG. 8 is a method according to some embodiments of the present disclosure. The method 800 may, in some embodiments, be implemented using an optical system such as the optical system 100 of FIG. 1, and/or may be included in or more the example methods of FIGS. 2-7.

The method 800 includes box 805, which describes training a machine learning model. The method 805 begins with box 810 which describes labelling a first tissue sample with a first labelling technique and a second labelling technique. The second labelling technique is targeted to a tissue structure of interest in the tissue sample, while the first labelling technique may be less specific. In some embodiments, the second labelling technique may be targeted to a biomarker associated with the tissue structure of interest. In some embodiments, the first labelling technique, the second labelling technique, or both may include a label free imaging technique. In some example embodiments, the first labelling technique may include labelling the tissue with H&E analogs, Mason's tri-chrome, periodic acid-Schiff (PAS), 4′,6-diamidino-2-phenylindole (DAPI) or combinations thereof, and the second labelling technique may include labelling the tissue with aptamers, antibodies, peptides, nanobodies, antibody fragments, enzyme-activated probes, and fluorescent in situ hybridization (FISH) probes.

The method 805 continues with box 820, which describes collecting a first depth stack of images of the first tissue sample. The depth stack may include a number of slices. In some embodiments, there may be multiple overlapping depth stacks of the same 3D volume of tissue, each associated with one of the labelling techniques. For example, a first set of images of the depth stack may image the first labelling technique, while a second set of images of the depth stack may image the second labelling technique. The two sets may have corresponding images which are co-localized. For example, the method may include generating a first image of a field of view based on the first labelling technique and then generating a second image of the same field of view based on the second labelling technique.

The method 805 continues with box 830, which describes training a machine learning model using the first depth stack of images to generate synthetic images of the tissue structure as they appear with the second labelling technique based on images using the first labelling technique. For example, the machine learning model may use corresponding pairs of images (e.g., an image of a given field of view with the first labelling technique and an image of the field of view with the second labelling technique) to train the model. The machine learning model may be a GAN model, such as a vid2vid GAN model. In some embodiments, the machine learning model may select a slice in the first depth stack (e.g., a given field of view) and use that slice as well as neighboring (e.g., adjacent) slices. The machine learning model may iteratively move through slices in this fashion.

The method 805 (e.g., boxes 810 to 830) may represent training a machine learning model. Once the training is complete (e.g., after box 830), the model may be stored, sent to other people, made available remotely (e.g., via the internet), packaged for distribution etc. In some embodiments, the training process may be repeated using additional data.

FIG. 8 also shows a method 845 of imaging using the machine learning model. The apparatuses and/or systems used to perform the methods 805 and 845 may be the same or may be different. For example a first system may train the machine learning model using method 805, while a different system may segment images using the method 845. In some embodiments, a single system (e.g., 100 of FIG. 1) may both train the model (e.g., method 805) and then at a later time segment images using that model (e.g., method 845). In some embodiments, a system may perform the method 845 based on a machine learning model which has been separately trained. In some embodiments, a model may be trained using the method 805, and then the method 845 may be repeated several times using the same trained model.

The method 845 includes box 840, which describes segmenting the tissue structure of interest in a second depth stack of images of a second tissue sample prepared with the first labelling technique based on the trained machine learning model. For example, the method 845 may include collecting a second depth stack of images of a second tissue sample. The first depth stack of images may be collected by a same or different microscope as the second depth stack of images. In some embodiments, the method 845 may include generating a synthetic depth stack based on the second depth stack of images and segmenting the tissue structure of interest in the synthetic depth stack. For example, the method 845 may include segmenting the synthetic depth stack. The method 845 may include generating a segmentation mask based on the synthetic depth stack, for example by applying a brightness threshold to the synthetic depth stack. In some embodiments, the segmentation mask may be generated based on the synthetic depth stack and the second depth stack.

The method 800 may include diagnosing a condition, monitoring a condition, making a prediction about progression of a condition, making a prediction about a treatment response or combinations thereof based on the identified tissue structure of interest in the second depth stack of images. For example, the method 800 may include determining one or more criteria based on the segmentation mask. In some embodiments, multiple tissue structures may be segmented and may be used. For example, structures of interest such as glands, nerves, epithelial cells, lymphocytes may be segmented and the combination of segmented tissues may be used to make predictions, monitor, etc.

In some embodiments, the method 800 may include collecting a third depth stack of images of the second tissue sample and generating a mosaic based on the second and the third depth stack of images. Similarly, the method 800 may include generating a synthetic second and third depth stack based on the second and third depth stacks respectively, and generating a synthetic mosaic image.

### Implemented Examples

An example implementation of the present disclosure is described herein. The example implementation may be referred to as image-translation-assisted segmentation in 3D (ITAS3D). In this specific implementation of ITAS3D, 3D H&E-analog images of prostate tissues are synthetically converted in appearance to predict (e.g., mimic) a second labelling technique, 3D immunofluorescence (IF) images of Cytokeratin 8 (CK8)—a low-molecular-weight keratin expressed by the luminal epithelial cells of all prostate glands—thereby facilitating the objective (biomarker-based) segmentation of the glandular epithelium and lumen spaces using traditional CV tools. The deep-learning image-translation model is trained with a generative adversarial network (GAN). This approach uses a “2.5D” virtual-staining approach based on a GAN that was originally designed to achieve video translation with high spatial continuity between frames, but which has been adapted within our ITAS3D framework to ensure high spatial continuity as a function of depth.

To investigate the value of a computational 3D pathology workflow vs. a computational 2D pathology workflow, 300 ex vivo biopsies were extracted from archived radical prostatectomy (RP) specimens obtained from 50 patients who underwent surgery over a decade ago. The biopsies were prepared with a first labelling technique using an inexpensive small-molecule (i.e., rapidly diffusing) fluorescent analog of H&E. The first labelling technique also include optically clearing the biopsies with a dehydration and solvent-immersion protocol to render them transparent to light, and then using an open-top light-sheet (OTLS) microscopy platform to obtain whole-biopsy 3D pathology datasets. The prostate glandular network segmented using ITAS3D, from which 3D glandular features (i.e., histomorphometric parameters) and corresponding 2D features were extracted from the 118 biopsies that contained prostate cancer (PCa). These 3D and 2D features were evaluated for their ability to stratify patients based on clinical biochemical recurrence (BCR) outcomes, which serve as a proxy endpoint for aggressive vs. indolent PCa.

Archived FFPE prostatectomy specimens were collected from 50 PCa patients of which 46 cases were initially graded during post-RP histopathology as having Gleason scores of 3+3, 3+4 or 4+3 (Grade Group 1-3). All patients were followed up for at least 5 years post-RP as part of a prior study (Canary TMA) (49). FFPE tissue blocks were identified from each case corresponding to the 6 regions of the prostate targeted by urologists when performing standard sextant and 12-core (2 cores per sextant region) biopsy procedures. The identified FFPE blocks were first de-paraffinized by heating them at 75° C. for 1 hour until the outer paraffin wax was melted, and then placing them in 65° C. xylene for 48 hours. Next, one simulated core-needle biopsy (˜1-mm in width) was cut from each of the 6 deparaffinized blocks (per patient case), resulting in a total of n=300 biopsy cores. All simulated biopsies were then fluorescently labeled with the T&E version of our H&E-analog staining protocol.

Biopsies were first washed in 100% ethanol twice for 1 h each to remove any excess xylene, then treated in 70% ethanol for 1 h to partially re-hydrate the biopsies. Each biopsy was then placed in an individual 0.5 ml Eppendorf tube, stained for 48 hours in 70% ethanol at pH 4 with a 1:200 dilution of Eosin-Y and a 1:500 dilution of To-PROT™-3 Iodide at room temperature with gentle agitation. The biopsies were then dehydrated twice in 100% ethanol for 2 hours. Finally, the biopsies were optically cleared (n=1.56) by placing them in ethyl cinnamate for 8 hours before imaging them with open-top light-sheet (OTLS) microscopy.

An OTLS microscope was used to image tissues slices (for training data) and simulated biopsies (for the clinical study). For this study, ethyl cinnamate (n=1.56) was used as the immersion medium, and a custom-machined HIVEX plate (n=1.55) was used as a multi-biopsy sample holder (12 biopsies per holder). Multi-channel illumination was provided by a four-channel digitally controlled laser package. Tissues were imaged at near-Nyquist sampling of ˜0.44 μm/pixel. The volumetric imaging time was approximately 0.5 min per mm³ of tissue for each wavelength channel. This allowed each biopsy (˜1×1×20 mm), stained with two fluorophores (T&E), to be imaged in ˜20 min.

Patient-level glandular features were obtained by averaging the biopsy-level features from all cancer-containing biopsies from a single patient. Patients who experienced BCR within 5 years post-RP are denoted as the “BCR” group, and all other patients are denoted as “non-BCR”. BCR was defined here as a rise in serum levels of prostate specific antigen (PSA) to 0.2 ng/ml after 8 weeks post-RP. To assess the ability of different 3D and 2D glandular features to distinguish between BCR vs. non-BCR groups, we applied ROC curve analysis, from which an area-under-the-curve (AUC) value could be extracted. The t-SNE(51) analyses were performed with 1000 iterations at a learning rate of 100.

To develop multiparameter classifiers to stratify patients based on 5-year BCR outcomes, a least absolute shrinkage and selection operator (LASSO) logistic regression model was developed using the binary 5-year BCR category as the outcome endpoint. LASSO is a regression model that includes a L1 regularization term to avoid overfitting and to identify a subset of features that are most predictive. Here, the optimal LASSO tuning parameter, λ, was determined with 3-fold cross validation (CV), where the dataset was randomly partitioned into three equal-sized groups: two groups to train the model with a specific λ, and one group to test the performance of the model. Along the LASSO regularization path, the λ with the highest R2 (coefficient of determination) was defined as the optimal L Due to the lack of an external validation set, a nested CV schema was used to evaluate the performance of the multivariable models without any bias and data leakage between parameter estimation and validation steps. The aforementioned CV used for hyperparameter tuning was performed in each iteration of the outer CV. LASSO regression was applied on the training set of the outer CV once an optimal λ was identified in the inner CV. AUC values were then calculated from the testing group of the outer CV. This nested CV was performed 200 times in order to determine an AUC (average and standard deviation). The exact same pipeline was used to develop multiparameter classifiers based on 3D and 2D features.

Kaplan Meier (KM) analysis was carried out to compare BCR-free survival rates for high-risk vs. low-risk groups of patients. This analysis utilized a subset of 34 cases for which time-to-recurrence data is available. The performance of the models, either based on 2D or 3D features, was quantified with p values (by log-rank test), hazard ratios (HR) and concordance index (C-index) metrics. For the multiparameter classification model used for KM analysis, the outer CV (3-fold) in our nested CV schema was replaced by a leave-one-out approach, where one case was left out of each iteration (50 total iterations) to calculate the probability of 5-year BCR for that patient. The samples were categorized as low- or high-risk by setting a posterior class probability threshold of 0.5.

To segment the 3D glandular network within prostate biopsies, we first trained a GAN-based image-sequence machine learning model to convert 3D H&E-analog images into synthetic CK8 IF images, which can be false colored to resemble chromogenic immunohistochemistry (IHC). As mentioned, the CK8 biomarker is expressed by the luminal epithelial cells of all prostate glands. The image-translation model is trained in a supervised manner with images from prostate tissues that are fluorescently tri-labeled with our H&E analog and a CK8-targeted monoclonal antibody (mAb).

For whole-biopsy H&E-to-CK8 conversion, first sub-divide the 3D biopsy (˜1 mm×0.7 mm×20 mm) datasets into ˜1 mm×0.7 mm×1 mm (˜1024×700×1024 pixel) blocks. Each 3D image block is treated as a 2D image sequence as a function of depth. At each depth level, a synthetic CK8 image is inferred from the H&E-analog image at that level while simultaneously utilizing the images (H&E analog and CK8) from two previous levels to enforce spatial continuity as a function of depth. This “2.5D” image translation method is based on a “vid2vid” method for video translation (time sequences rather than depth sequences). However, the modified model of this example embodiment omits the “coarse-to-fine” training strategy implemented in the original vid2vid method because this enables training times to be minimized with negligible performance loss. Once the synthetic CK8 image blocks are generated, they are mosaicked to generate a whole-biopsy CK8 IHC dataset for gland segmentation. In step 2, the synthetic CK8 dataset is used to segment the luminal epithelial cell layer via a thresholding algorithm. The gland-lumen space, which is enclosed by the epithelium layer, can then be segmented by utilizing both the epithelium segmentation mask and the cytoplasmic channel (eosin-analog images).

While the glands can be delineated on the H&E-analog images by a trained observer, automated computational segmentation of the glands remains challenging. Here the 3D image translation based on H&E-analog inputs results in synthetic-CK8 outputs in which the luminal epithelial cells are labeled with high contrast and spatial precision. These synthetic-CK8 datasets allow for relatively straightforward segmentation of the gland epithelium, lumen, and surrounding stromal tissue compartments. Glands from various PCa subtypes are successfully segmented, including two glandular patterns that are typically associated with low and intermediate risk, respectively: small discrete well-formed glands (Gleason 3) and cribriform glands consisting of epithelial cells interrupted by multiple punched-out lumina (Gleason 4). To demonstrate improved depth-wise continuity with our 2.5D image-translation strategy versus a similar 2D image-translation method (based on the “pix2pix” GAN), vertical cross-sectional views of a synthetic-CK8 dataset. The results of our 2.5D image-sequence translation exhibit optimal continuity with depth. Abrupt morphological discontinuities between levels are obvious with 2D translation but absent with the 2.5D translation approach. To quantify the performance of our image-translation method, a 3D structural similarity (SSIM) metric was calculated in which real CK8 IF datasets were used as ground truth. For images generated with 2.5D vs. 2D image translation, the 3D SSIM (averaged over 58 test volumes that were 0.2-mm3 each) was 0.41 vs. 0.37, reflecting a 12% improvement at a p value of 7.8×10-6 (two-sided paired t-test). This enhanced image-translation performance facilitates accurate 3D gland segmentations in subsequent steps of our computational pipeline.

To assess segmentation performance, ground-truth gland-segmentation datasets were first generated under the guidance of board-certified genitourinary pathologists (L.D.T. and N.P.R.). A total of 10 tissue volumes from different patients (512×512×100 pixels each, representing 0.2-mm3 of tissue) were manually annotated. We then compared the accuracy of ITAS3D with that of two common methods: 3D watershed (as a 3D non-DL benchmark) and 2D U-Net (57) (as a 2D DL benchmark) ITAS3D outperforms the two benchmark methods in terms of Dice coefficient and 3D Hausdorff distance.

Due to the slow rate of progression for most PCa cases, an initial clinical study to assess the prognostic value of 3D vs. 2D glandular features was performed with archived prostatectomy specimens. This example implementation consisted of N=50 PCa patients who were followed up for a minimum of 5 years post-RP as part of the Canary TMA case-cohort study (primarily low- to intermediate-risk patients). The Canary TMA study was based on a well-curated cohort of PCa patients in which the primary study endpoints were 5-year BCR outcomes and time to recurrence, which are also used as endpoints for our validation study. In the original Canary TMA study, approximately half of the patients experienced BCR within 5 years of RP, making it an ideal cohort for our study. A randomly selected a subset of 25 cases that had BCR within 5 years of RP were assigned to a “BCR” group, and 25 cases that did not have BCR within 5 years of RP were assigned to a “non-BCR” group.

FFPE tissue blocks were identified from each case corresponding to the 6 regions of the prostate targeted by urologists when performing standard sextant and 12-core (2 cores per sextant region) biopsy procedures (FIG. 4a). Next, a simulated core-needle biopsy was extracted from each of the 6 FFPE tissue blocks for each patient (n=300 total biopsy cores). The biopsies were deparaffinized, labeled with a fluorescent analog of H&E, optically cleared, and imaged nondestructively with a recently developed OTLS microscope. Review of the 3D pathology datasets by pathologists (L.D.T. and N.P.R.) revealed that 118 out of the 300 biopsy cores contained cancer (1-5 biopsies per case). The ITAS3D pipeline was applied to all cancer-containing biopsies. We then calculated histomorphometric features from the 3D gland segmentations, and from individual 2D levels from the center region of the biopsy cores, which were then analyzed in terms of their association with BCR outcomes. For 2D analysis, average values from a total of 3 levels were calculated, in which the three levels were separated by 20 microns (mimicking clinical practice at many institutions).

Multiple 3D and 2D glandular histomorphometric features were compared. For example, the curvature of the boundary between the lumen and epithelium is a feature that increases as glands become smaller or more irregular, as is often seen with aggressive PCa. This can be quantified in the form of the average surface curvature of the object in 3D, or the curvature of the object's cross-sectional circumference in 2D. As another example, the gland-to-convex-hull ratio (G/H) is defined as the volume ratio (in 3D) or the area ratio (in 2D) of the gland mask (epithelium+lumen) divided by the convex hull that circumscribes the gland. This G/H feature is inversely related to the irregularity or “waviness” of the periphery of the gland (at the scale of the gland itself rather than fine surface texture), which is generally expected to increase with aggressive PCa. For various 3D and 2D features, receiver operating characteristic (ROC) curves were generated to quantify the ability of the features to stratify patients based on 5-year BCR outcomes. When comparing analogous 3D and 2D glandular features, the 3D features largely exhibit an improved correlation with 5-year BCR outcomes in comparison to their 2D counterparts. This is exemplified by the significant p values for the 3D features (between BCR and non-BCR groups) and higher area-under-the-ROC-curve (AUC) values.

The 3D skeleton of the lumen network was also extracted and its branching parameters (skeleton-derived features) were quantified. Here, a “gland skeleton” is defined as a collection of lines that approximate the center axes of various glands as they propagate in 3D space (similar to a line representation of a vessel network). Due to the complex 3D branching-tree architecture of the gland-lumen network, there are no straightforward 2D analogs for these skeleton-derived features. Two examples of skeleton-derived features: the average branch length and the variance of the branch lengths. Both features are correlated with BCR outcomes based on p values and AUC values. Our analysis reveals that aggressive cancers (BCR cases) have shorter branch lengths and a smaller variance in branch lengths, which agrees with prior observations from 2D histology that glandular structures in higher-grade PCa are smaller and more abundant (i.e., less differentiated and varied in size). A histogram of branch lengths demonstrates that the vast majority of branches are <200-μm long, which suggests that the diameter of standard prostate biopsies (˜1-mm) is sufficient for whole-biopsy 3D pathology to quantify PCa branch lengths with reasonable accuracy.

To explore the prognostic value of combining multiple glandular features, logistic regression models were used for feature selection and classification based on 3D vs. 2D features. The ROC curve of a model that combined 12 non-skeleton 3D features (“3D non-skeleton model”) yielded an AUC value of 0.80±0.05 (average±standard deviation), which is considerably higher than the AUC value (0.65±0.06) of the model trained with 12 analogous 2D features (“2D model”). By adding 5 skeleton-derived features to the 12 non-skeleton 3D features, a re-trained 3D multiparameter model (“3D model”) yielded a slightly higher AUC value of 0.81±0.05. The distribution of the 50 cases, based on their glandular features, can be visualized using t-distributed stochastic neighbor embedding (t-SNE), where a clearer separation between BCR and non-BCR cases is evident based on 3D vs. 2D glandular features. Multiparameter classification models based on 3D features alone (non-skeleton) or 2D features alone were used to divide patients into high- and low-risk groups based on 5-year BCR outcomes, from which Kaplan-Meier (KM) curves of BCR-free survival were constructed for a subset of cases in which time-to-recurrence (BCR) data are available. Compared to the 2D model, the 3D model is associated with a higher hazard ratio (HR) and C-index, along with a significant p value (p<0.05), suggesting superior prognostic stratification.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

It should be understood that terms like ‘top’ and ‘side’ are used for ease of explanation, and are only meant to indicate the relative positioning of various components. Other embodiments may use other arrangements of components. Various components and operations may be described with respect to certain wavelengths of light. It should be understood that other wavelengths (such as those outside the visible spectrum) would be used, and that light as used herein may represent any electromagnetic radiation. Certain materials may be described in terms of their optical properties (e.g., transparent) and it should be understood that materials with the desired properties may be chosen for any wavelength(s) of light used by the system.

Finally, the above-discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

What is claimed is:

1. A method comprising:
labelling a first tissue sample with a first labelling technique and a second labelling technique, wherein the second labelling technique is targeted to a tissue structure of interest and the first labelling technique has a lower specificity to the tissue structure;
collecting a first depth stack of images of the tissue;
training a machine learning model using the first depth stack of images to generate synthetic images of the tissue structure as they appear with the second labelling technique based on images using the first labelling technique; and
segmenting the tissue structure of interest in a second depth stack of images of a second tissue sample prepared with the first labelling technique based on the trained machine learning model.

2. The method of claim 1, wherein the machine learning model is configured to process a selected slice of the second depth stack of images along with slices adjacent to the selected slice.

3. The method of claim 2, wherein the machine learning model is a vid2vid general adversarial network (GAN).

4. The method of claim 1, wherein the first labelling technique includes labelling with H&E analogs, Mason's tri-chrome, periodic acid-Schiff (PAS), 4′,6-diamidino-2-phenylindole (DAPI) or combinations thereof, and wherein the second labelling technique includes labelling with aptamers, antibodies, peptides, nanobodies, antibody fragments, enzyme-activated probes, and fluorescent in situ hybridization (FISH) probes.

5. The method of claim 1, wherein the first labelling technique, the second labelling technique or combinations thereof include label free imaging.

6. The method of claim 1, wherein the second labelling technique is targeted to a biomarker associated with the tissue structure of interest.

7. The method of claim 1, further comprising:
collecting the first depth stack of images with a first microscope; and
collecting the second depth stack of images with a second microscope.

8. The method of claim 1, further comprising diagnosing a condition, monitoring the condition, making a prediction about progression of the condition, making a prediction about treatment response, or combinations thereof based on the identified structure of interest in the second depth stack of images.

9. The method of claim 1, further comprising taking a third depth stack of images of the second tissue sample and generating a mosaic image based on the second and the third depth stack of images.

10. The method of claim 1, further comprising generating a synthetic depth stack based on the second depth stack and the machine learning model, wherein the synthetic depth stack predicts the appearance of the second tissue if it were prepared with the second labelling technique.

11. The method of claim 10, further comprising segmenting the tissue structure of interest in the second depth stack of images based on the synthetic depth stack.

12. A method comprising:
generating a first set of images of a tissue sample;
generating a second set of images of the tissue, wherein the second set include targeted labelling of a tissue structure of interest of the tissue sample, and wherein the first set of images are less specific to the tissue structure; and
training a machine learning model to generate synthetic images from the first set of images which predict an appearance of the second set of images.

13. The method of claim 12, further comprising:
generating a third set of images of a second tissue sample, wherein the third set of images are less specific to the tissue structure of interest; and
segmenting the tissue structure of interest in the third set of images based on using the trained machine learning model on the third set of images.

14. The method of claim 12, further comprising training a general adversarial network (GAN) as the machine learning model.

15. The method of claim 12, wherein the first set of images and the second set of images are a depth stack of the tissue.

16. The method of claim 15, further comprising training the machine learning model to generate the synthetic images based on iteratively processing a selected slice of the depth stack along with neighboring slices of the depth stack.

17. A method comprising:
imaging a depth stack of images of a tissue using a first labelling technique;
generating a synthetic depth stack of images from the imaged depth stack of images using a machine learning model, wherein the synthetic depth stack of images predict an appearance of the tissue as if it was prepared using a second labelling technique and wherein the second labelling technique is targeted to a tissue structure of interest and the first labelling technique is less specific to the tissue structure of interest.

18. The method of claim 17, further comprising segmenting the tissue structure of interest based on the synthetic depth stack of images.

19. The method of claim 18, further comprising segmenting the tissue structure of interest based on the depth stack of images.

20. The method of claim 17, further comprising diagnosing a condition, monitoring the condition, making a prediction about progression of the condition or combinations thereof based on the synthetic depth stack of images.

21. The method of claim 17, further comprising training the machine learning model based on a second depth stack of images of a tissue prepared using the first labelling technique and the second labelling technique.

22. The method of claim 17, further comprising imaging the depth stack of images of the tissue using an open top light sheet microscope.

23. An apparatus comprising:
a microscope configured to generate a depth stack of images of a tissue prepared with a first labelling technique;
a processor;
a memory encoded with executable instructions which, when executed by the processor, cause the apparatus to:
generate a synthetic depth stack of images from the imaged depth stack of images using a machine learning model, wherein the synthetic depth stack of images predict an appearance of the tissue like it was prepared with a second labelling technique and wherein the second labelling technique is targeted to a tissue structure of interest and the first labelling technique is less specific to the tissue structure of interest.

24. The apparatus of claim 23, wherein the tissue has a thickness of 5 um or greater.

25. The apparatus of claim 23, wherein the microscope is an open top light sheet (OTLS) microscope.

26. The apparatus of claim 23, wherein the machine learning model is trained on a depth stack of images of a second tissue prepared with the first labelling technique and the second labelling technique.

27. The apparatus of claim 23, wherein the first labelling technique includes labelling the tissue with H&E analogs, Mason's tri-chrome, periodic acid-Schiff (PAS), 4′,6-diamidino-2-phenylindole (DAPI) or combinations thereof, and wherein the second labelling technique includes labelling the tissue with aptamers, antibodies, peptides, nanobodies, antibody fragments, enzyme-activated probes, and fluorescent in situ hybridization (FISH) probes.

28. The apparatus of claim 23, wherein the machine learning model is trained on another processor.

29. The apparatus of claim 23, wherein the memory further includes instructions which, when executed by the processor, cause the apparatus to generate a segmentation mask based on the synthetic depth stack of images.

30. The apparatus of claim 29, wherein the memory further includes instructions which, when executed by the processor, cause the apparatus to generate the segmentation mask based on the synthetic depth stack of images and the imaged depth stack of images.
